(19) United States
(12) Patent Application Publication
(10) Pub. No.: US 2019/0375201 A1
(43) Pub. Date: Dec. 12, 2019

(54) CONFORMABLE POLYETHYLENE FABRIC AND ARTICLES MADE THEREFROM

(71) Applicant: E I DU PONT DE NEMOURS AND COMPANY, Wilmington, DE (US)

(72) Inventor: James Neal Singletary, Midlothian, VA (US)

(21) Appl. No.: 16/000,937

(22) Filed: Jun. 6, 2018

(51) Int. Cl. B32B 27/12; B32B 27/32; B32B 5/02; B32B 3/26; B32B 5/06; B32B 5/12; B32B 5/26; B32B 7/08; B32B 27/30; B32B 27/08; F41H 5/04

(52) U.S. Cl. CPC B32B 27/12; B32B 2571/02; B32B 5/028; B32B 5/022; B32B 3/266; B32B 5/06; B32B 5/12; B32B 5/26; B32B 7/08; B32B 27/308; B32B 27/08; B32B 5/024; F41H 5/0485; B32B 2307/56; B32B 2307/581; B32B 2307/54; B32B 2262/0253; B32B 2262/0261; B32B 27/32

(57) ABSTRACT

A fabric comprises a highly drawn UHMWPE non-filamentary sheet having a width of at least 10 mm and a plurality of impalements wherein one impalement is separated from the next impalement by a distance of at least 1 mm. The fabric may further comprise a plurality of said sheets wherein each sheet is stacked one on top of the other.

### BACKGROUND

### 1. Field of the Invention

This invention pertains to a fabric of oriented polyethylene sheets suitable for use in an impact or cut resistant laminate.

### 2. Background of the Invention

Sheets of ultra-high molecular weight polyethylene polymer, as described for example in U.S. Pat. No. 8,075,979 to Weedon et al., are known for their efficacy as a component of a ballistic-resistant article. When used in components that are highly contoured such as those with having a curvature in two simultaneous directions, there is a tendency for damage to the sheet such as crimp, tearing, buckling or permanent restraining tension. There is a need therefore for improved polyethylene sheets that are easily conformed without damage for use in complex shapes. Further, there is a need for said improved polyethylene sheets to be supplied in a fabric that is self-supporting and can be easily handled.

U.S. Pat. No. 5,578,373 to Kobayashi describes a polyethylene stretched material which is then subjected to splitting. The split polyethylene material according to the invention has a large surface area and accordingly can be easily laminated to other materials, and has a high strength and flexibility. Such split films can be combined to make self-supporting fabrics. However, this material has a disadvantage of requiring the loose, split films to be subsequently handled in their loose, easily unraveled state.

### SUMMARY OF THE INVENTION

This invention pertains to a fabric comprising a highly drawn UHMWPE non-filamentary sheet having a width of at least 10 mm and a plurality of impalements wherein one impalement is separated from the next impalement by a distance of at least 1 mm.

### BRIEF DESCRIPTION OF THE DRAWINGS

FIGS. 1A, 1B and 1C show planar views of impalement patterns of exemplary fabrics.

FIG. 2 shows a cross section through a cross-plied non-fibrous ultra-high molecular weight (UHMWPE) polyethylene fabric.

FIG. 3 is an end view of the test rig used to measure fabric drapeability.

### DETAILED DESCRIPTION

The date and/or issue of specifications referenced in this section are as follows:

ASTM D7744-11 was published in September 2011.
ASTM D4440-07 was published in March 2007.
MIL-DTL-662F was published in December 1997.
MIL-DTL-46593B was published in 2006.
NIJ-0115.00 was published in 2000.

Fabric

In one embodiment, the fabric comprises a single highly drawn UHMWPE non-filamentary sheet that has a plurality of impalements wherein one impalement is separated from the next impalement by a distance of at least 1 mm. Preferably, the fabric has a width of at least 10 mm. More preferably, the fabric has a width of at least 40 mm. Yet more preferably, the fabric has a width of at least 100 mm. Most preferably, the fabric has a width of at least 200 mm.

In another embodiment, the fabric comprises a plurality of highly drawn UHMWPE non-filamentary stacked sheets. In one embodiment of such a fabric, each sheet in the stack is placed in an orientation such that the direction of draw in one sheet is offset with respect to the direction of draw in the next sheet. In a preferred embodiment, each sheet in the stack is placed in an orientation such that the direction of draw in one sheet is orthogonal with respect to the direction of draw in the next sheet. In yet another embodiment of such a fabric, each sheet in the stack is placed such that there is no offset with respect to the direction of draw in the next sheet i.e. all sheets have the direction of draw in the same direction.

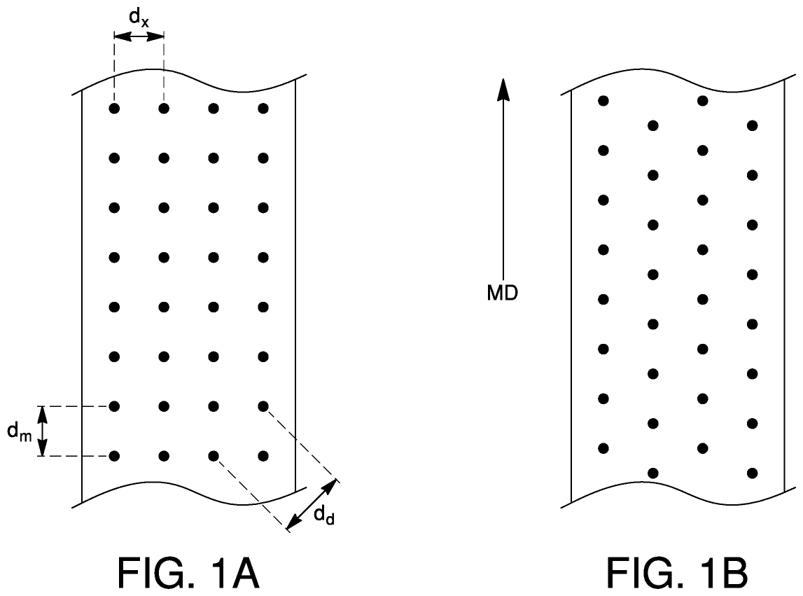

In the above fabrics, the impalement in the sheet may be a slit (cut), a hole or a filament passing through the plane of the sheet. Preferably, the slits or cuts are made so that the film is parted parallel to the draw direction, without rupturing product in the film's draw direction. FIGS. 1A and 1B show examples of two impalement arrangements or patterns. For convenience, the impalement in these two figures are shown as holes. FIG. 1B differs from FIG. 1A in that impalements in some rows are offset with respect to impalements in other rows, relative to location down the draw direction of the topmost oriented film.

The impalements are made while or after the fabric is being assembled.

In the above fabrics, one impalement is separated from the next impalement by a distance, ‘d’ of at least 1, 2, 4, 6, 8 or 10 mm. In this context, adjacent rows of impalement means rows of impalement that are next to each other. In FIGS. 1A and 1B, the impalement spacing may be between impalements in the machine direction (dₘ), between impalements in the cross direction (dₓ) or impalements in a diagonal direction (d_{d}), whatever is the smallest. Machine direction (MD) is a well-known term and is the direction in which the roll is formed on a machine. In some embodiments, impalements in one row may be offset with respect to impalements in an adjacent row. A random arrangement of impalements may also be envisaged where one impalement is separated from the next impalement by a distance of at least 1, 2, 4, 6, 8 or 10 mm. In further embodiments, the fabrics described above may comprise a non-UHMWPE polymeric film, a nonwoven sheet, a woven fabric or an adhesive adjacent to the UHMWPE sheet or sheets.

Any suitable filamentary material such as nylon or polyester may be used for passing through the plane of the sheet or the stack of sheets. In some embodiments, these filaments pass through the plane of the sheet or stack of sheets at an angle of from 70 to 90 degrees with respect to the plane of the sheet or stack of sheets.

When the fabric comprises a plurality of sheets, it is preferred that the impalement of the sheets of the fabric is carried out after the sheets have been assembled in a stack. However, each individual sheet may be impaled and then assembled into a stack.

In some embodiments, the fabric comprises a plurality of sheets, preferably two or four and, optionally, a bonding adhesive having a maximum areal weight of 10 gsm that is located between the sheets. In some embodiments the weight of the adhesive layer is less than 8 gsm or even less than 4 gsm.

In other embodiments, the optional adhesive further comprises a textile layer which may be a scrim or nonwoven fabric.

An exemplary fabric is shown at 10 in FIG. 1C. This fabric comprises two layers 11 and 12 arranged such that the impalements 13 and 14 are oriented in draw directions MD11 and MD12 respectively. Further, layer 11 is arranged such that its draw direction is orthogonal to the draw direction of layer 12.

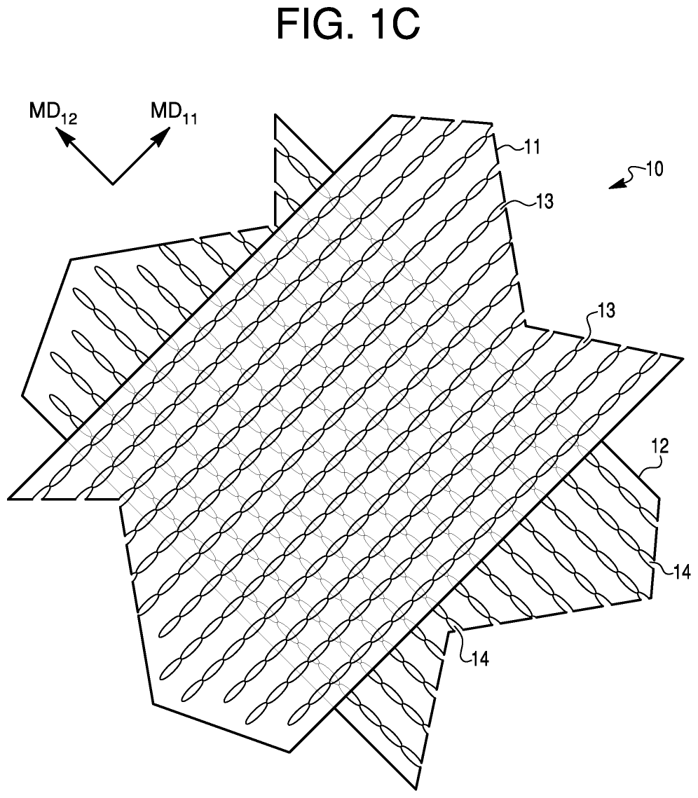

A further exemplary fabric is shown at 20 in FIG. 2 and comprises two sheets of UHMWPE oriented sheet 21 and 22 and two layers of adhesive 23. The direction of orientation of one sheet 21 is offset with respect to the direction of orientation of the other sheet 22. Preferably the two oriented sheet layers 21 and 22 have an orientation that is essentially orthogonal to each other. By “essentially orthogonal” is meant that the two sheets are positioned relative to each other at an angle of 90+/−15 degrees. This is sometimes referred to as a 0/90 arrangement.

Two adhesive layers 23 are positioned a shown in FIG. 2. The fabric 20 described above comprises two sheets and two adhesive layers. A sheet may comprise more than two sheets or more than two adhesive layers such as in a 0/90/0/90 arrangement.

Structures without any adhesive or only a few layers of adhesive are also envisaged.

Structures without any adhesive on their exteriors are also envisioned as are structures laminated to abrasion-resistant polymer sheets.

The fabrics described herein are meant to refer to thin sections of material in widths greater than about 0.2 m and up to or exceeding 1.6 m width as could be produced in large commercial equipment specifically designed for production in such widths and having a rectangular cross-section and smooth edges.

### Polyethylene Sheet

In the context of this disclosure, the terms sheet, film, or monolayer are interchangeable. The sheet is non-filamentary and is highly oriented.

Impalement in these highly oriented sheets create long tears parallel to the direction of orientation of each layer, thus creating disconnected or substantially disconnected elements. The resulting fabric can substantially deform in in-plane shear. When the sheets are not highly drawn (oriented), e.g. when the sheets have similar strength in both the machine and cross directions, then the fabric will not conform to the desired shape under in-plane shear.

Preferably, the sheet has a tenacity of at least 1.3 N/tex (15 gpd).

The term “sheet” as used herein refers to ultra-high molecular weight polyethylene (UHMWPE) sheet products having widths on the order of at least 10 mm or 12.5 mm or greater, preferably greater than 20 mm, more preferably greater than 30 mm or more preferably greater than 40 mm or even greater than 100 mm of a generally rectangular cross-section and having smooth edges, and is specifically used to distinguish from the “fibrous” UHMWPE products that are on the order of 3 mm wide or narrower. Representative UHMWPE sheets of the present invention have a width of at least about 25 mm, a thickness of between 0.02 mm and 0.102 mm when measured, using calipers, at minimal pressure, preferably between 0.02 and 0.06 mm, more preferably between 0.027 and 0.058 mm, and a first modulus, defined as “M1” in ASTM D7744-11, of at least about 100 N/Tex, preferably at least about 115 or 120 N/Tex, more preferably at least about 140 N/Tex, and most preferably at least about 160 N/Tex. In some embodiments, the sheet has a very high width to thickness ratio, unlike fibrous UHMWPE, which has a width that is substantially similar to the thickness. A UHMWPE sheet according to the present invention, for example, may include a width of 25.4 mm and a thickness of 0.0635 mm, which indicates a width to thickness ratio of 400:1. The sheet may be produced at a linear density of from about 660 Tex to about 1100 Tex and higher. There is no theoretical limit to the width of the high modulus polyethylene sheet, and it is limited only by the size of the processing equipment.

The term “UHMWPE” or “UHMWPE powder” as used herein refers to the polymer used in the process of making the sheet of this invention. The UHMWPE powder preferably has a crystallinity of at least 75% as determined by differential scanning calorimeter (DSC) and more preferably at least 76%. The polymer also has a specific heat of fusion of greater than 220 joules/gram also determined by DSC. The molecular weight of the polymer is at least 1,000,000, more preferably at least 2,000,000 and most preferably greater than 4,000,000. In some embodiments the molecular weight is between 2-8 million or even 3-7 million. During procesing, the polymer is preferably not exposed to more than 1 degree C. above the onset of melt determined by DSC and preferably is maintained below the onset of melt during formation of the rolled sheet. Preferably, the crystalline structures have low entanglement. Low entanglement allows the polymer particles to elongate during rolling and drawing to the high total draws required to obtain the high modulus of this invention. Such commercially available polymers as GUR-168 from Ticona Engineering Polymers and 540RU or 730MU from Mitsui Chemicals can be used to obtain the very high modulus tape of this invention. Both these polymers have an onset of melt between 135.5 to 137 degrees C. Low entanglement as used herein refers to the ability of the polymer crystalline structure as used in the UHMWPE tape of the present invention, to easily stretch to high draw ratios while being pulled or stretched. Polymers with highly entangled crystalline structures do not have the ability to be stretched easily without damage and resulting loss of properties and polymers with a high amorphous content (lack of high crystallinity) cannot develop the required properties. Many classes of UHMWPE polymers are highly amorphous and have low crystallinity. The percentage crystallinity can be determined using a differential scanning calorimeter (DSC).

Production of a high modulus UHMWPE sheet according to the present invention can be performed in two parts, as described herein, or in a single process step. Preferably, in order to provide a high and efficient throughput, the invention includes a direct roll process coupled with a subsequent drawing process. This drawing process is sometimes referred to as an orientation process. In the descriptions herein, the term “total draw” or “total draw ratio” refers to the total amount of elongation of the original polymer particles. Elongation occurs in two steps, rolling and drawing and total draw is equal to the elongation in rolling times the elongation during drawing. Draw may be accomplished in multiple steps, in which case total draw is the product of rolling draw and each individual draw step. The first draw or rolling step, involves elongation of the polymer particles to form a rolled sheet. The elongation or draw amount during rolling is the length of a polymer particle after rolling divided by the particle size prior to rolling. A sheet or web with particles that have been elongated by 2 times is considered as being drawn 2 times. In order to produce a substantially strong finished sheet suitable for high modulus applications the rolled sheet draw amount is 4 to 12 times and the most preferred draw amount in rolling is 5 to 11 times or even 7 to 11 times. Thus, this implies that most preferably the UHMWPE particles are elongated or lengthened 5 to 11 times their original length during rolling. A rolled sheet with elongations of 11 will exhibit a much higher degree of orientation compared to a sheet with an elongation of 2. As an example, for a sheet rolled to an elongation of 6 and further drawn 20 times in the drawing step, the total draw is 6×20 or 120, while an elongation of the initial rolled sheet of 10 that is drawn 20 times will have a total draw of 200. Typical post draw ranges for the oriented sheet are 18 to 25 when the rolling draw is 5 to 9. While it is possible to obtain suitable properties for some applications, for production of the high modulus UHMWPE sheet according to the current invention, the total draw, also known as total draw ratio, is preferably above 100 and may be as high as 160 or 180 or 200 or higher depending on the polymer molecular weight, crystallinity, and degree of entanglement of the crystal structures. Orientation and modulus of the UHMWPE sheet increases as the total draw or draw ratio increases. The term “highly oriented” or “highly drawn” sheet as used herein refers to polyolefin sheet drawn to a total draw ratio of 100 or greater, which implies that the polymer particles within the tape have been stretched in a single direction 100 times their original size. During drawing of UHMWPE according to the present invention, several properties including length, material orientation, physical tensile properties such as strength and modulus, heat of fusion, and melt temperature will typically increase. Elongation, thickness and width will typically decrease. In some embodiments, the roll drawing is carried out at a temperature in the range of 130-136.5° C. or from 130-136° C. A preferred range is from 134-136° C.

Preferably, the sheet has a maximum areal weight of no greater than 60 g/m², a thickness of from 25 μm to 75 μm and a density of between 600 and 950 kg/m³. In other embodiments, the maximum areal weight of the sheet may be no greater than 50 g/m² or 35 g/m² or 30 g/m² or 25 g/m² or 20 g/m². In yet other embodiments, the density of the sheet is from 600 to 850 kg/m³ or 600 to 750 kg/m³ or 600 to 680 kg/m³.

The density of the sheet will increase if it is compressed after manufacturing under sufficient pressure to permanently deform the original sheet, and will ultimately approach the density of a polyethylene crystal if the sheet is under sufficiently high pressure. Compression under elevated temperature will further increase sheet density.

### Adhesive

The optional adhesive 23 in FIG. 2 is placed adjacent to the surface of each sheet to bond adjacent sheets together. Preferably, each adhesive layer has a basis weight of no greater than 10 gsm.

Suitable examples of adhesive include urethanes, polyethylene, polyamide, ethylene copolymers including ethylene-octene copolymers, ethylene vinyl acetate copolymer, ethylene acrylic acid copolymer, ethylene/methacrylic acid copolymer, ionomers, metallocenes, and thermoplastic rubbers such as block copolymers of styrene and isoprene or styrene and butadiene. The adhesive may further comprise a thixotrope to reduce the propensity for adjacent sheets to slide relative to each other during a compression process. Suitable thixotropes include organic particles whose shape can be characterized as dendritic (representative of which is DuPont™ Kevlar® aramid fiber pulp), spherical, plate-like, or rod-like, or inorganic particles such as silica or aluminum trihydrate. The adhesive may further include other functional additives such as nanomaterials and flame retardants to create other desired attributes such as color, fire response, odor, biological activity, different surface energy, and abrasion resistance.

In some embodiments, the adhesive may be in the form of a sheet, paste or liquid and may further comprise a textile layer which may be a scrim or nonwoven fabric.

### Article

The fabrics described above may be a component in an article, exemplary examples being a ballistic-resistant or cut-resistant article.

The number of fabrics or number of sheets comprising the fabric in an article will vary based on the design requirements of the finished article. A typical weight of fabric or fabrics in the article ranges from 0.1 to 600 kg/m² or from 1 to 60 kg/m² or even from 1 to 40 kg/m². In some embodiments, the article is formed by compression of a stack of fabrics at a temperature at which the adhesive will flow but is less than the temperature at which the sheet of the fabric loses orientation, and thus mechanical strength. Typically, the adhesive comprises no more than 15 weight percent of the combined weight of polyethylene tape plus adhesive in the laminate.

The article may further comprise at least one layer of continuous filament fibers embedded in a matrix resin. The fibers may be provided in the form of a woven fabric, a warp- or weft-insertion knitted fabric, a non-woven fabric or a unidirectional fabric, these terms being well known to those in the textile art.

By “matrix resin” is meant an essentially homogeneous resin or polymeric material in which the fibers are embedded or coated. The polymeric resin may be thermoset or thermoplastic or a mixture of the two. Suitable thermoset resins include phenolic such as PVB phenolic, epoxy, polyester, vinyl ester and the like. Suitable thermoplastic resins include a blend of elastomeric block copolymers, polyvinyl butyral, polyethylene copolymers, polyimides, polyurethanes, polyesters and the like.

### Ballistic Protection

In the context of this application, we define a material as having “ballistic protection or resistance” when the material can absorb up to at least 15 J/(kg-m²) of projectile kinetic energy normalized by material areal density, when impacted by right circular cylinders of steel, striking with their flat ends parallel to the surface of the material, where the projectile mass is approximately 1.04 g and the projectile diameter is approximately 5.56 mm.

### Test Methods

### Sheet Tensile Properties

Sheet tensile properties were determined per ASTM D7744-11. When the sheet was impractical to test in tension at full width, specimens were prepared by removing strips from the sheet. The strips were around 2-4 mm wide and were parallel to the machine direction. They were removed by tearing the edge of the sheet and then advancing the tear through the sheet, parallel to the orientation direction, by gently pulling a filleted steel strip of around 1-mm width through the sheet. Loose fibrils were removed from the edges by passing the strip lightly between fingers. Specimens were tabbed with Scotch® Magic™ tape (3M, Saint Paul, Minn.). Modulus is taken as M1 as defined in ASTM D7744.

### Sheet Dimensions and Mass

Unless otherwise noted, length dimensions of greater than 1-mm were measured by eye with a ruler, precise to 1 mm. Sheet thickness was measured with a caliper precise to 0.01 mm, contacting the sheet between flat surfaces and taking thickness as the highest indicated value at which the sheet could not be pulled freely by hand through the caliper. Mass of sheet strips for lineal mass and density measurements were measured on a weigh scale precise to 0.001 g.

### Sheet Lineal Density and Density

Sheet lineal density was calculated by creating strips using the method described above for tensile test specimens, measuring their length and mass as described above, and calculating lineal density. Sheet density was calculated by dividing lineal density by sheet thickness (measured as described above) and by sheet strip width. Sheet strip width was measured with a caliper precise to 0.01 mm, by placing the sheet strip wide cross sectional dimension parallel to the direction of travel in the movable caliper jaw, slowly reducing the width of the caliper, and taking width as the highest value at which the sheet does not freely pass between the caliper jaws.

### Ballistic Penetration Performance:

Ballistic tests of the fabric laminates were conducted in accordance with standard procedures MIL STD-662F (V50 Ballistic Test for Armor). Tests were conducted using 1.04-gram right circular cylinders of oil rod steel, impacting end on against the laminate targets. One article was tested for each of the examples with 10 shots, at zero degree obliquity, fired at each target.

### Cut Resistance

Cut resistance was measured per ASTM F2992/F2992M-15.

### EXAMPLES

The following examples are given to illustrate the invention and should not be interpreted as limiting it in any way. All parts and percentages are by weight unless otherwise indicated. Examples prepared according to the process or processes of the current invention are indicated by numerical values. Control or Comparative Examples are indicated by letters.

### Stitch Bonded Fabric Construction

Stitch bonding is a well known term in the textile art and is a technique in which fibers are connected by stitches that are sewn or knitted through the fabric or sheet. This is also known as quilting.

Fabrics of Examples 1-24 and Comparatives A-C of the invention were created by impaling approximately 24-cm wide sheets of highly drawn UHMWPE (Tensylon® grade HS, from DuPont Safety & Construction, Wilmington, Del., drawn over 100 times and with a typical tenacity as-drawn of 21.5±0.5 grams-force per denier, as measured by ASTM D7744-11). The sheets had a linear density of around 108,000 denier. The films were impaled in courses approximately 1.8 mm wide (dₓ) in the cross direction, using conventional barbed sewing needles with smooth shanks, which tended to split the highly drawn UHMWPE sheet but not rupture it perpendicular to the draw direction, and then stitched with 77-dtex/34-filament, texturized nylon into a 0-1/1-2 tricot stitch in the same process, using a stitch bonding machine. The tricot stitches were approximately 2.5-mm apart in the machine direction. In all cases, the fabrics were bonded to a lightweight polymer nonwoven scrim to stabilize the fabric and improve handling.

### Example 1

A fabric as described above was manufactured by combining one highly drawn UHMWPE non-slit sheet of Tensylon® and one layer of a cross-plied open mesh fabric of polyethylene strands (CLAF from JX Nippon ANCI Inc, Kennesaw, Ga.) having a nominal 30-gsm basis weight. The open mesh fabric was used to capture the stitching yarns on the so-called “technical face”, and provided additional stability to the fabric in the cross direction, and could also be subsequently used as a thermoplastic resin for future molding. “Technical face” is a term understood in the stitch bonded fabric art and is referenced, for example, in U.S. Pat. No. 9,049,974 to Wildeman.

The fabric was tested for cut resistance perpendicular to the machine direction, per ASTM F2992/F2992M-15. The test results were evaluated per ANSI/ISEA 105-2016 to have a Cut Resistance Performance Level of A2.

### Example 2

A fabric like Example 1 was manufactured, but the open mesh fabric was replaced with a nylon nonwoven of nominal 50-gsm basis weight.

### Example 3

A fabric like Example 2 was manufactured, but contained two layers of Tensylon® sheet thus increasing the fabric basis weight, thickness and break force. The two Tensylon® sheets were aligned with the draw in the same direction.

### Example 4

A fabric like Example 2 was manufactured, but contained three layers of Tensylon® sheet, further increasing the fabric basis weight, thickness and break force. The Tensylon® sheets were aligned with the draw in the same direction.

### Example 5

A fabric like Example 2 was manufactured, but contained four layers of Tensylon® sheet, yet further increasing the fabric basis weight, thickness and break force. The Tensylon® sheets were aligned with the draw in the same direction.

### Example 6

A fabric like Example 2 was manufactured, but contained five layers of Tensylon® film, further increasing the fabric basis weight, thickness and break force. The Tensylon® sheets were aligned with the draw in the same direction.

The fabric was tested for cut resistance perpendicular to the machine direction, per ASTM F2992/F2992M-15. The test results were evaluated per ANSI/ISEA 105-2016 to have a Cut Resistance Performance Level of A3.

### Example 7

A fabric like Example 2 was manufactured, but contained seven layers of Tensylon® film, further increasing the fabric basis weight, thickness and break force. The Tensylon® sheets were aligned with the draw in the same direction.

### Example 8

A fabric like Example 3 was manufactured, but the Tensylon® sheets were oriented with the direction of draw alternating in the machine- and cross-directions of the fabric. This fabric offered balanced, biaxial strength and stiffness while still being conformable.

### Example 9

A fabric like Example 2 was manufactured, but had a total of nine ultradrawn UHMWPE sheets alternately oriented in the machine- and cross directions, with machine direction oriented sheets on the outside nearest the fabric faces. This fabric provided high biaxial break force and stiffness, but was still conformable.

### Example 10

A fabric like Example 8 was manufactured, but also included a polymer film between the highly drawn UHWMPE sheet layers, and between the UHMWPE sheet layers and the faces of the fabric. The polymer film was DuPont™ Surlyn® brand ionomer, with an approximate basis weight of 4-gsm. This fabric offers high biaxial break force and stiffness, but is still conformable. Further, the fabric could have its shape fixed by thermoplastic molding.

### Example 11

A fabric like Example 10 was manufactured, except that the polymer film was replaced with a nonwoven scrim of polyethylene copolymer (product code 412DPF from Spunfab, Ltd., Cuyahoga Falls, Ohio) of 6-gsm basis weight. This fabric offers high biaxial break force and stiffness, but was still conformable. Further, the fabric could have its shape fixed by thermoplastic molding.

### Example 12

The stitching yarns of the the fabric of Example 6 were carefully removed from the fabric while leaving the Tensylon® sheets intact. The sheets were seen to be interconnected with ligands between neighboring elements in each sheet layer. Elements of the polyethylene sheets were separated manually from their connecting ligands, and then tested for tenacity per ASTM D7744-11. The resulting, mean tenacity was 21.3-grams force per denier. This is within the typical range of tenacity of the film tested as-drawn, before fabric manufacture, as noted above. This proves that this invention can effectively translate the useful reinforcing properties of highly drawn, but nonconforming UHMWPE sheets into a conformable fabric when using needles with smooth sides.

### Example 13

Two layers of the fabric of Example 6 were placed between layers of 500-denier nylon 6,6 woven fabric style CTD500, secured by elastic bands to a piece of wood, and engaged with a chain saw moving at full chain speed. The uppermost layer of nylon fabric was cut through immediately. However, elements of highly drawn UHMWPE sheet in the uppermost layer of the fabric pulled free of the fabric, traveled with the chain back into the drive gear, and then immediately jammed the chain saw, before the chain was able to damage the second layer of the invented fabric. This proves that the fabric could offer valuable protection against chain saws.

### Example 14

Fabrics described in Examples 1 through 11 were deformed by hand in two directions. They all proved able to accommodate curvature simultaneously in two directions without buckling, and maintain their deformed shapes without continuous tension. This demonstrates that our invention is capable of creating conformable fabrics from what are otherwise non-conforming materials.

### Example 15

Fabric described in Example 10 was heated between parallel, steel platens at a temperature of 125° C. and a pressure of 34-Bar, then cooled under pressure to room temperature before releasing pressure. The fabric was rigidified by the melting and subsequent freezing of the adhesive film. This demonstrates that our invention can be used to make fabrics that can be rigidified by means of heat and pressure.

### Example 16

Fabric described in Example 2 was wetted with a room temperature curing epoxy resin (West Systems Type 105 from West Marine), then bent at a right angle and allowed to harden. The fabric was rigidified and maintained its shape. This demonstrates that our invention can enable the reinforcement of complex, curved composite articles.

### Example 17 and Comparative Example A

Fabrics described above in Examples 6 and 8 (uniaxially- and biaxially reinforced fabrics, respectively), alongside a comparative fabric, Comparative A (Tensylon® HSBD30A from DuPont), reinforced with highly drawn UHMWPE film (Tensylon® HS, from DuPont), were tested for air permeability per ASTM D737-04, using a TexTest FX-3300 measurement device (from TexTest AG, Schwerzenbach, Switzerland) with a 38-cm² orifice and default settings. Average air flow was measured at 6.5-cm³/s/cm² for multiple readings of both Examples 6 and 8 of the invented fabrics. Air flow was too low to be measured for the Comparative Example of the prior art. This demonstrates that the invention improves on the comparative art by creating fabrics capable of allowing fluid flow. This is valuable for air flow in personal comfort, and for liquid flow in the impregnation and bonding of composites.

### Example 18

A conformable fabric was manufactured from five layers of Tensylon® highly drawn polyethylene sheet and a layer of CLAF cross-plied open mesh fabric on the technical face. The films were impaled in courses approximately 1.8-mm wide in the cross direction, and then stitched with 77-dtex/34-filament, texturized nylon into a 0-1/1-2 tricot stitch in the same process, using a stitch bonding machine.

The fabric was tested for cut resistance perpendicular to the machine direction, per ASTM F2992/F2992M-15. The test results were evaluated per ANSI/ISEA 105-2016 to have a Cut Resistance Performance Level of A3.

### Comparative Example B

A fabric like Example 18 above was made, except that instead of the multiple layers of highly drawn polyethylene sheet, a biaxially oriented, melt extruded polyester film, 0.92-gage (about 23-micrometers), from DuPont Teijin Films, Hopewell, Va., was incorporated. The resulting fabric was not shear conformable, because holes from perforations through the film did not tear consistently into rows to create nearly disconnected, individual strips, but instead remained a periodic array of disconnected holes. This comparative example demonstrates that the claimed invention is not simply a perforated sheet made from melt extrusion but one which has been highly drawn, so that holes from impalements will propagate under tension and/or shear to form cracks parallel to the draw direction in order for the manufacturing process to create nearly disconnected, parallel strips from the original sheets. Such properties are not practical with melt extruded films.

### Comparative Example C

A fabric like Example 18 above was made, except that instead of the multiple layers of highly drawn polyethylene sheet, a single layer of moderately, uniaxially drawn polyethylene sheet (extended around six times original length in the machine direction) was used. The total basis weight was similar to Example 18. Around seven times uniaxial draw is near the practical upper limit to the draw possible with normal film melt extrusion.

The resulting fabric was not shear conformable, because holes from perforations through the film did not tear consistently into rows to create nearly disconnected, individual strips, but instead remained a periodic array of disconnected holes. This comparative example demonstrates that the claimed invention is not simply a perforated sheet made with any arbitrary amount of uniaxial draw. Instead, the invention requires special properties of preferential crack propagation noted above in the sheet in order for the manufacturing process to create nearly disconnected, parallel strips from the original sheets. Such properties are not practical with sheets uniaxially drawn to draw ratios of about seven or lower, and instead require higher draw often done in multiple steps.

### Example 19

A conformable fabric was manufactured from one layer of Tensylon® highly drawn polyethylene sheet and a layer of entangled nonwoven of para-aramid fiber (DuPont™ “Z11” nonwoven fabric, made from DuPont™ Kevlar® brand aramid fiber). The films were impaled in courses approximately 1.8-mm wide in the cross direction, and then stitched with 77-dtex/34-filament, texturized nylon into a 0-1/1-2 tricot stitch in the same process, using a stitch bonding machine. This example demonstrates that the cross-reinforcing element on the technical face of our fabric can have additional functionality—in this case, cut resistance, tear resistance and thermal protection inherent in a para-aramid nonwoven.

### Example 20

A conformable fabric like Example 19 was manufactured, except the fabric comprised four layers, in order A-B-A-B, where A is a Tensylon® sheet and B is Z11 para-aramid nonwoven, with layer B being the technical face of the fabric. This example demonstrates that the fabric of the invention can also incorporate fibrous materials in the plane of the fabric, which can enhance desired properties such as bulk, abrasion resistance, and toughness.

### Example 21

A conformable fabric like Example 19 was manufactured, except the fabric had six layers, of order A-B-A-B-A-B, where A is Tensylon® highly drawn polyethylene sheet and B is Z11 para-aramid nonwoven, with B on the technical face of the fabric. This example demonstrates that interior layers of the fabric of our invention can be made with fibrous materials.

### Example 22

A conformable fabric like Example 18 was made, except that the course width was around 3.6-mm wide. The fabric resisted deformation more than the fabric created in Example 18, but would deform into a shape curved in two directions, and maintain the deformed shape without restraint. This shows that our invention can allow a compromise between fabric rigidity (increased with larger courses) and flexibility and drawability (increased with smaller courses). Such compromises may be valuable for fabrics that require some conformability but less that would be needed in garments, such as geotextiles.

### Example 23

A stitch bonded fabric of Example 6 was manufactured as described above containing five highly drawn UHMWPE sheets, all aligned with the draw direction parallel to the machine direction, and one layer of CLAF cross-plied open mesh fabric of about 30-gsm basis weight. The cross-plied CLAF fabric was used to capture the stitching yarns on the technical face and provide additional stability to the fabric in the cross direction.

### Example 24

Two pieces of the fabric made in Example 23 were laid perpendicular to each other with the technical faces contacting, so that the midplane normal of the highly drawn UHMWPE sheets were antiparallel. This assembly was pressed to 60-Bars pressure between steel platens heated to 121° C., then allowed to cool under pressure to around 25° C. The resulting, laminated fabric expanded the teaching of Example 1 by bonding the fabric of the invention into a composite fabric. Since the highly drawn UHMWPE sheets were biaxially oriented, the fabric had useful tensile strength in two directions.

Examples of Forming Conformal Fabrics from Highly Drawn Film by Impalement

Fabrics of Examples 25-47 and Comparative Examples D-F were constructed by passing multiple layers of material through a needle loom, which perforated the fabric with barbed needles, snagging elements of the layers and perforating lower layers of material with them to form a self-supported fabric. Fabrics in the following examples had as their bottom layer a nylon fiber nonwoven substrate of approximately 30-gsm to facilitate handling during manufacture. A needle loom is a well known technology in the textile trade.

Photomicrographs of fabrics needled in the examples below showed a random pattern of impalements of a density of about 30 per square centimeter, unless noted otherwise. Neither the randomness of the hole pattern nor the hole density are limitations of the invention. Contrary to conventional teachings, a non-random hole pattern may be preferred in some embodiments.

### Example 25

A single layer of DuPont™ Tensylon® highly drawn polyethylene sheet, grade HS, with a width of around 24 cm and a linear density of around 108,000, was needled onto a nylon nonwoven substrate as previously described. Elements of the polyethylene sheet were liberated from the Tensylon® sheet and passed into the substrate, creating a self-supporting, connected fabric structure. This demonstrates an embodiment of this invention, that the highly drawn polyethylene sheet itself may be used to create entanglements in an entangled fabric. This is a surprising result, given the strength, rigidity and low coefficient of friction of highly drawn polyethylene sheets. The resulting fabric was conformable.

### Example 26

A batting of polyester fibers was needled into the same Tensylon® sheet material as used in Example 25, and then into a previously entangled, para-aramid nonwoven (DuPont™ Kevlar® Z11), using a random hole pattern as described above. The resulting fabric was conformable.

### Example 27

A batting of polyester fibers was needled into the same Tensylon® sheet material as used in Example 25, and then into a previously entangled, para-aramid nonwoven (DuPont™ Kevlar® Z11), using random hole pattern in the needle board, but with some needles removed, to create about 2-cm wide strips parallel to the machine direction, in which the highly drawn polyethylene sheet was not damaged. The resulting fabric, compring in order, one layer of polyester nonwoven, one polyethylene sheets and one layer of p-aramid nonwoven was conformable, but less conformable than the fabric created in Example 26. This may be valuable for fabrics that require periodic, large, pristine elements for load bearing or tear resistance, such as rip stop fabrics.

### Example 28

A fabric like Example 27 was created, except the lane spacings dₓ were about 4-cm wide. This demonstrates that our invention is not constrained to a specific width of strip. The fabric was conformable.

### Examples 29-31

Fabrics like those in Examples 26-28 were created, except that instead of a batting of polyester fibers, a loose batting of 52-mm nominal length para-aramid fiber (DuPont™ Kevlar®) was needled into the Tensylon™ highly drawn polyethylene sheet, and then into a previously entangled, para-aramid nonwoven (DuPont™ Kevlar® Z11). This demonstrates that the entangling fibers of our invention can have high strength and additional functionality in the fibers that penetrate the highly drawn sheet—in this case, high strength, cut resistance and thermal resistance. It also demonstrates that fabrics of our invention can be formed by direct incorporation of loose fibers. The fabric was conformable.

### Example 32

Two layers of a plain weave 168 gsm fabric made from 10 cm wide UHMWPE tape films (Dyneema BT10 from DSM Dyneema LLC, Greenville, N.C.) were impaled into a nylon nonwoven carrier at about 32 impalements (holes) per square centimeter. The fabrics were conformable. This demonstrates that the highly drawn sheet substrates of our invention, when slit into tape films, are suitable for weaving processes.

### Example 33

A fabric like Example 32 was manufactured, except that the hole density was increased to around 60 holes per square centimeter. This demonstrates that our invention is not limited to one specific hole density, but instead, highly drawn polyethylene films can withstand even very dense patterns of perforation. The fabric was conformable.

### Example 34

A nonwoven, cross-plied, laminated fabric of highly drawn polyethylene sheets, laminated with a linear low density polyethylene adhesive (DuPont™ Tensylon® style HSBD30A), was needle punched into a nylon nonwoven at about 30 impalements per square centimeter in an essentially random pattern. The laminated fabric was conformable.

### Example 35

The laminate containing the highly drawn polyethylene sheet component of the fabric created in Example 33 was removed from the nylon nonwoven. This demonstrates that the nonwoven substrate used to facilitate processing in these examples is not an essential requirement of the invention if the permeability is imparted by impaling. The fabric was conformable.

### Example 36

The perforated fabric of cross-plied, laminated, highly drawn polyethylene sheets manufactured in Example 34 was measured for air permeability as described in Example 17 and Comparative Example A. Average air permeability was 6.5-m³/s/m². Considering Comparative Example A, this demonstrates that our invention can create a permeable fabric from an initially essentially impermeable starting material.

### Example 37

The perforated fabric of cross-plied, laminated, highly drawn polyethylene sheets manufactured in Example 35 was sheared by hand from an initially square shape to a non-right parallelogram. The fabric easily sheared 25-degrees by hand without wrinkling, representing a change in the orientation of the drawn directions of the highly drawn polyethylene film layers from 90-degrees initially to 65-degrees. This demonstrates that this invention could be used to make reinforced thermoplastic components with curvature in multiple directions without wrinkling. In contrast, Comparative Example A could not be sheared by hand into a non-right parallelogram.

### Examples 38-40 and Comparative Example D

Perforated fabric of cross-plied, laminated, highly drawn polyethylene sheets using DuPont™ Tensylon® HSBD30A were manufactured similar to Example 35, but at different impalement densities and patterns, using a needle loom. Special care was taken in the arrangement of the needle loom to create not only the expected, random impalement array, but also in generating rectangular impalement arrays.

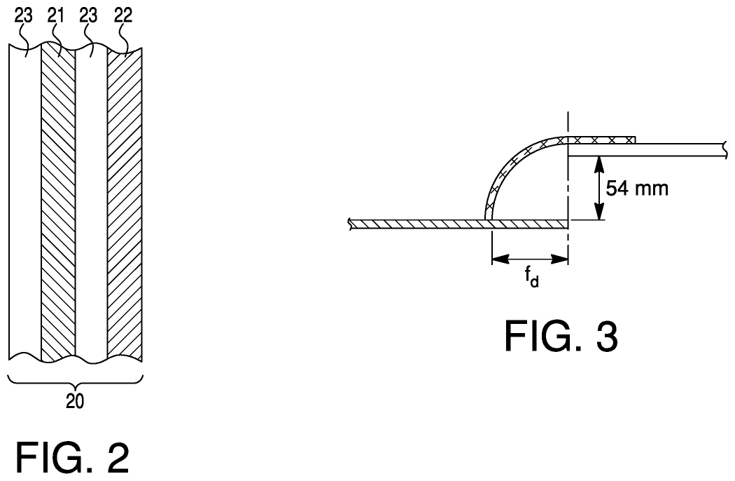

2-cm wide strips of cross-plied fabric were cut with the long direction of the strip either parallel or orthogonal to the long direction of the fabric roll. A strip was laid flat on a smooth surface, perpendicular to gravity, and slowly slid off the edge of the surface until the tip of the cantilevered section of the fabric contacted, at a distance Id′, a ruler parallel to the initial direction of the strip but located 54 mm below the smooth surface. This is shown in FIG. 3. Several strips were measured in each direction of each fabric, and with each face of the fabric up, and the average length of the cantilevered sections recorded. This is a measure of fabric drapeability. Drapeability increases as the mean distanced cantilevered drop ‘d’ to the ruler decreases.

Samples of 45 layers of the perforated fabrics were cut in 22.8×22.8-cm squares, parallel to the fabric machine and cross directions, and compressed between steel platens at 204 Bar pressure. Fluoropolymer-treated fiberglass release plies were placed between the steel platens and the samples to prevent bonding. The platens were then heated to 110° C. for 20 minutes, and then cooled to less than 40° C. before pressure was released. The resulting, molded plaques were tested for the mean velocity to barely perforate (“V50”) by high speed impacts. Table 1 shows the impalement density, impalement pattern, mean cantilevered distance (inversely related to drapeability) of single layers, and V50 of compression molded plaques, along with a control of the same material with no impalements.

TABLE 1
Drapeability and ballistic protection for samples made in Example 38.

| | | | Mean | 45-layer | 45-layer | 45-layer | Specific |
|---|---|---|---|---|---|---|---|
| | | Impalement | cantilever | plaque areal | plaque | plaque | Energy |
| | Impalement | density | distance | density | thickness | V50 | Absorbed |
| Sample | Pattern | (cm⁻²) | (cm) | (kg/m²) | (mm) | (m/s) | (J-m²/kg) |
| Comparative | none | 0 | 175 | 5.21 | 5.4 | 549 | 31.9 |
| Example D | | | | | | | |
| Example 38 | Rectangular | 2.3 | 165 | 5.17 | 5.4 | 535 | 30.6 |
| | Array | | | | | | |
| Example 39 | Rectangular | 4.2 | 130 | 5.24 | 5.4 | 535 | 30.2 |
| | Array | | | | | | |
| Example 40 | Random | 26.4 | 129 | 5.39 | 5.7 | 404 | 16.7 |

Table 1 reveals some surprising findings over the current art. One skilled in the art of needlepunching will assume that the preferred impalement pattern is random. Exemplary of this is the Dictionary of Fiber & Textile Technology by Hoechst Celanese which defines that in a needle loom, “The needles are spaced in a nonaligned arrangement.” Comparing Example 40 to Example 39, it appears that the conventional wisdom of having to create a random array of impalements is not necessary in order to significantly increase drapeability. Further, surprisingly, comparing Examples 39 and 40, it appears that, for some embodiments, a regular (here, rectangular) array of impalements may be preferred over the random arrays accepted in conventional wisdom for improved end use efficacy. Comparing Examples 38 and 39 to Comparative Example D, it appears that our invention allows fabrics with enhanced drapeability that still retain at least the vast majority of their impact protective ability compared to the prior art.

### Examples 41-43 and Comparative Example E

Material made per Examples 38 through 40 above were evaluated on a thermoforming machine (model 686 from Formech, Middleton, Wis.). 610-mm×610-mm squares were held on a perforated table by drawing a vacuum through the perforations in the table, then further fixated by an ellipsoidal aluminum ring with a silicone rubber bearing surface. A hemi-ellipsoidal, aluminum shaped plug approximately 130-mm high and 230-mm across the major semi-axis was pushed up into the sample material, forcing it to take a compound curvature, all at room temperature (around 22° C.). As a comparison, single plies of a laminate made from non-impaled films of DuPont™ Tensylon® HA120 were subjected to the same test at varying temperatures between around 22° C. and 100° C., in the hopes that elevated temperature would soften the fabrics sufficiently to allow them to conform to the compound curvature. Room temperature samples of the inventive examples were able to conform to the compound curvature imposed with few or no wrinkles, with the amount of wrinkles related inversely to the impalement density. In contrast, at any temperature, fabrics of the comparative examples wrinkled substantially. This demonstrates that even significant compound curvature characteristic of valuable shapes such as radomes and helmets can be manufactured with fewer or even no defects introduced by wrinkles, which are inherent to fabrics of the comparative material. Further, such a draw forming process should favorably reduce manufacturing cost of forming compound curved parts from non-draping reinforcements by cutting and darting individual layers, and then working to align the cuts and darts to achieve an approximately homogeneous distribution of their effect in compromising strength.

### Examples 44-47 and Comparative Example F

DuPont™ Tensylon® HA120 is a nonwoven fabric made with four layers of highly drawn UHMWPE sheets disposed such that the orientation of maximum draw in one sheet was orthogonal to the orientation of maximum draw in an adjacent sheet, with all sheets bonded by an ethylene copolymer thermoplastic adhesive. The assembly was thermoformed into a deeply double curved shape using the equipment described above. The fabrics were 61-cm squares. Comparative Example F was non-impaled DuPont™ Tensylon® HA120. Inventive Examples 44-47 were DuPont™ Tensylon® HSBD30A which had been pulled through a roller set in which the top roller was steel and contained a regular, rectangular array of conical spikes, and the bottom roller had grooves that allowed the spikes of the top roller to pass into the widest diameter of the bottom roll. The two gears were linked by a chain so that the top and bottom rolls turned at the same speed. Pulling fabrics through the roll set created a square pattern of perforations, nominally 6.4-mm on a side. The distance between the roll centers could be adjusted, so that the conical needle holes could be made larger or smaller. Some samples were passed through the roller once and others twice, creating two superposed, rectangular hole patterns. All hole patterns were parallel with the orientation directions of the highly drawn films. The inventive fabrics remained connected and could be handled easily without concern for breakage or additional damage. Hole spacing and hole sizes were measured, and hole shapes were examined with an optical microscope. Unlike previous examples described above in which barbed needles were used, the highly drawn films did not rupture perpendicular to their draw directions, but instead, only ruptured parallel to their draw directions, and displaced in lenticular holes around the penetrating needles.

The thermoforming device was heated to a nominal temperature of 80° C. 61-cm square pieces of fabric were conditioned in the heated machine for 15-seconds, then the plug was raised in three steps to thermoform the fabric. The formed fabrics were photographed on the plug in the fully formed shape. Digital images were then superposed over a circle, and the image reduced or enlarged until the circle overlaid the edge of the plug, so that all images were scaled to the same dimensions. An ellipse was then superposed on the image around the crown of the thermoformed fabric, and adjusted to be as large as possible without encompassing wrinkles. Thus, the larger the ellipse, the more easily the material could drape to the double curvature of the plug. The ratio of the unwrinkled areas were compared to judge the efficacy of the invention to improve the drapability of fabrics comprising highly drawn UHMWPE films over the other art.

| | | | | | Relative |
|---|---|---|---|---|---|
| | | Number | | Number | mean area of |
| | Holes | of passes | Hole | of | largest ellipse |
| | Size | through | density | replicate | that had no |
| Material | (mm) | rollers | (cm⁻²) | samples | wrinkles |
| Comparative | None | None | 0 | 1 | 1.0 |
| Example F | | | | | |
| Example 44 | 0.6 | 1 | 2.5 | 1 | 1.5 |
| Example 45 | 1.3 | 1 | 2.5 | 2 | 1.9 |
| Example 46 | 0.6 | 2 | 5.0 | 2 | 1.9 |
| Example 47 | 1.3 | 2 | 5.0 | 2 | 2.3 |

Qualitatively, Comparative Example F had large, deep wrinkles, which would not press flat to the touch in subsequent compression molding in matched metal die. In contrast, the invented materials had small wrinkles which would be more likely to press flat if subsequently molded.

These results show that this invention can valuably increase the ability of otherwise essentially undrapeable fabrics reinforced with highly drawn UHMWPE sheets to drape into complex shapes. Further, they show that this improvement can be achieved without rupturing the sheets in their load bearing directions, improving their utility in applications where their strength and stiffness is critical. Finally, they show that desired drape can be achieved by a combination of controlling hole size and hole density, allowing flexibility in design. One skilled in the art of thermoforming would note that wrinkling of the invented fabrics could be further reduced with additional restraint during the forming process.

### UTILITY OF THE INVENTION

This invention can find utlity in a variety of applications such as protective fabrics against chain saw cuts, as a reinforcement material for resins, as a component in body armor applications and as a reinforcement for thermoplastic pipes and cable wrappings.

1. A fabric comprising a highly drawn UHMWPE non-filamentary sheet having a width of at least 10 mm and a plurality of impalements wherein one impalement is separated from the next impalement by a distance of at least 1 mm and the impalements are in the form of slits passing through the plane of the sheet.

2. (canceled)

3. The fabric of claim 1, wherein the one impalement in the fabric is separated from the next impalement by a distance of at least 2, 4, 6, 8 or 10 mm.

4. The fabric of claim 1, further comprising a non-UHMWPE polymeric film, a nonwoven sheet, a woven sheet or an adhesive adjacent to the UHMWPE sheet.

5. The fabric of claim 1, wherein the highly drawn UHMWPE non-filamentary sheet has a tenacity of at least 15 gpd (1.3 N/tex).

6. The fabric of claim 1, wherein the plurality of impalements are arranged in rows.

7. The fabric of claim 1, wherein the plurality of impalements are in a random arrangement.

8. The fabric of claim 2, wherein the filaments passing through the plane of the sheet do so at an angle of from 70 to 90 degrees with respect to the plane of the sheet.

9. The fabric of claim 6, wherein the impalements in one row are offset with respect to the impalements in the next row.

10. A fabric comprising a plurality of sheets of claim 1, wherein each sheet is stacked one on top of the other.

11. The fabric of claim 10, wherein each sheet in the stack is placed in an orientation such that the direction of draw in one sheet is offset with respect to the direction of draw in the next sheet.

12. The fabric of claim 10, further comprising filaments passing through the plane of the stack of sheets.

13. The fabric of claim 10, further comprising a non-UHMWPE polymeric sheet, nonwoven sheet, a woven sheet or an adhesive adjacent to the UHMWPE sheet.

14. The fabric of claim 10, wherein each sheet in the stack is placed in an orientation such that the direction of draw in one sheet is orthogonal with respect to the direction of draw in the next sheet.

15. The fabric of claim 12, wherein the filaments passing through the plane of the sheet do so at an angle of from 70 to 90 degrees with respect to the plane of the sheet.

16. An article comprising a fabric of claim 1 or of claim 10.

17. The article of claim 16, wherein the article is ballistic-resistant or cut-resistant.

18. The article of claim 17, wherein the ballistic-resistant article has a kinetic energy absorption per areal density against 1.04-gram, 5.56-mm diameter, right circular steel cylinders impacting end of 15 J-m²/kg or higher.

19. The article of claim 17, wherein the cut-resistant article has a Cut Resistance Performance Level of A2 or greater, as determined by the analysis defined in ANSI/ISEA 105-2016 from cut resistance data generated via test method ASTM F2992/F2992M-15.
